(19) United States
(12) Patent Application Publication
(10) Pub. No.: US 2021/0298368 A1
(43) Pub. Date: Sep. 30, 2021

(54) Hooded pull-over garment with detachable reusable and interchangeable face mask

(71) Applicant: Pocco Scott David Deaundrea Bussey, Arlington, VA (US)

(72) Inventor: Pocco Scott David Deaundrea Bussey, Arlington, VA (US)

(21) Appl. No.: 17/113,236

(22) Filed: Dec. 7, 2020

Related U.S. Application Data
(60) Provisional application No. 63/001,644, filed on Mar. 30, 2020.

(51) Int. Cl. A41D 1/04; A41D 15/00; A41D 13/11

(52) U.S. Cl. CPC A41D 1/04; A41D 2200/20; A41D 13/1161; A41D 15/00

(57) ABSTRACT

This invention concerns hoodie garments, Such garments have a sewn on, tied on, Velcro secured on, or otherwise attached button, knob, or other similar device on the middle part of the head covering portion of the hoodie so as to provide a support point for a facemask across a user's mouth and nose.

### BACKGROUND

This invention concerns hoodie garments. Such garments have a sewn on” tied on, Velcro secured on, or otherwise attached button, knob, or other similar device on the middle part of the head covering portion of the hoodie so as to provide a support point for a facemask across a user's mouth and nose.

Users often wear a face mask to go outdoors if they are sick or in fear of getting sick from others. However traditional masks are secured by placing elastic, rope, or other similar means around a users ears. This method can become painful to users.

Gamers have a particular need to hold portable game consoles to free up their hands in order to use a cell phone while carrying the game consoles,

It is an object of the present invention to provide a hoodie with a convenient to use capability which allows a user to secure a facemask over the Mouth and nose of a user without placing the mask straps around a users' ears.

### SUMMARY OF THE INVENTION

The above object and other objects which will be understood upon reading the following specification and claims are achieved by button, knob, or similar item sewn on the exterior of the side of the hoodie's head piece.

### DESCRIPTION OF THE DRAWINGS

FIG. 1 is a perspective al view from the front of a hoodie according to the present invention.

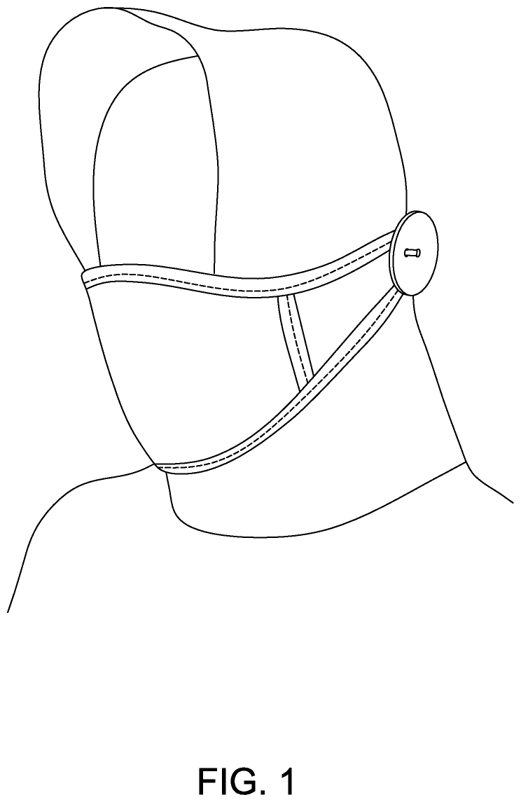

FIG. 2 is a second perspective view of the hoodie.

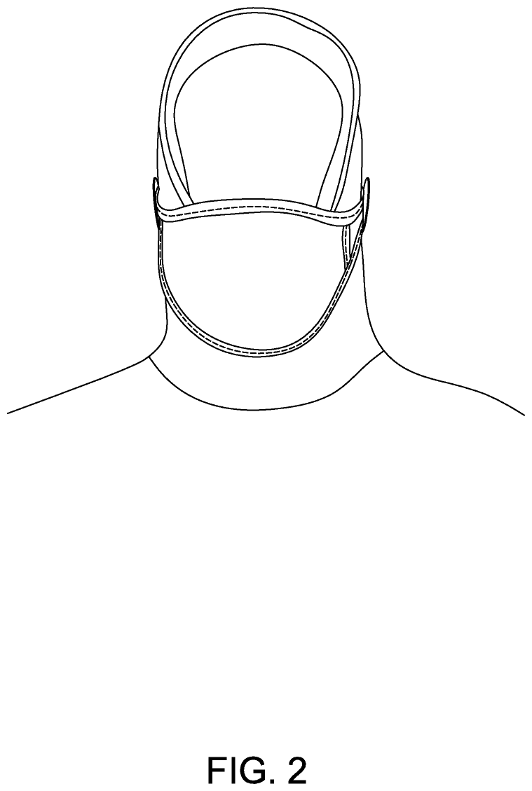

FIG. 3. is a third perspective view of the hoodie.

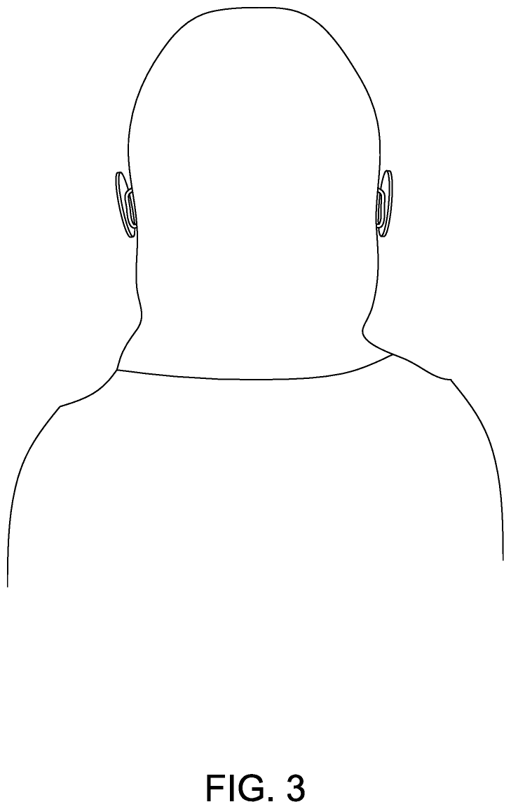

FIG. 4 is a fourth perspective view of the hoodie.

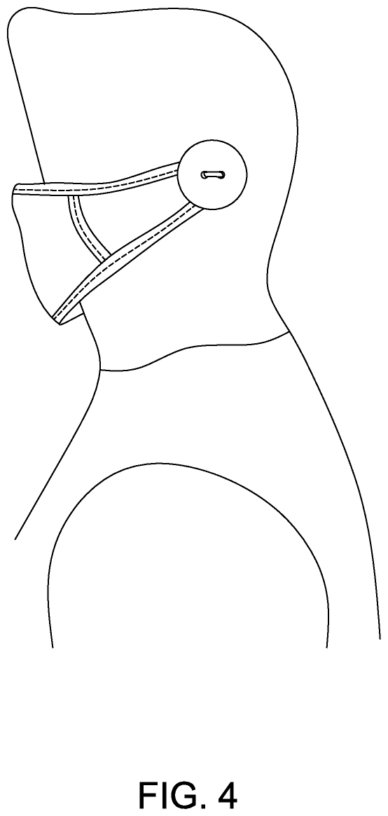

FIG. 5 is a fifth perspective view of the hoodie.

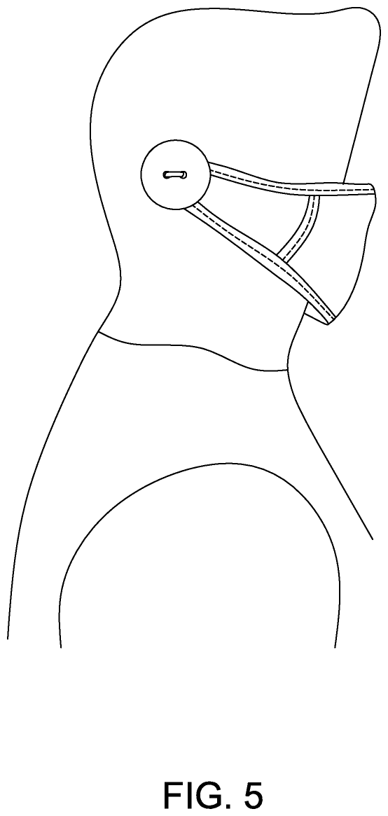

FIG. 6 is a sixth perspective view of the hoodie.

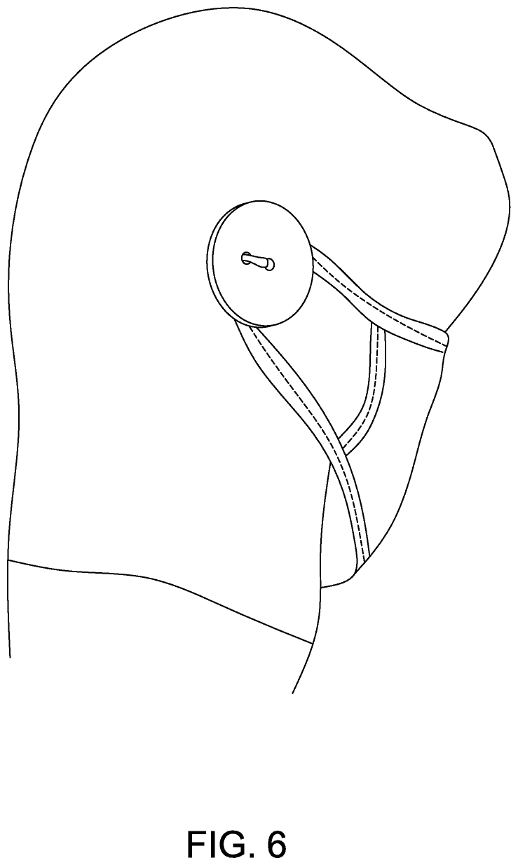

FIG. 7 is a seventh perspective view of the hoodie.

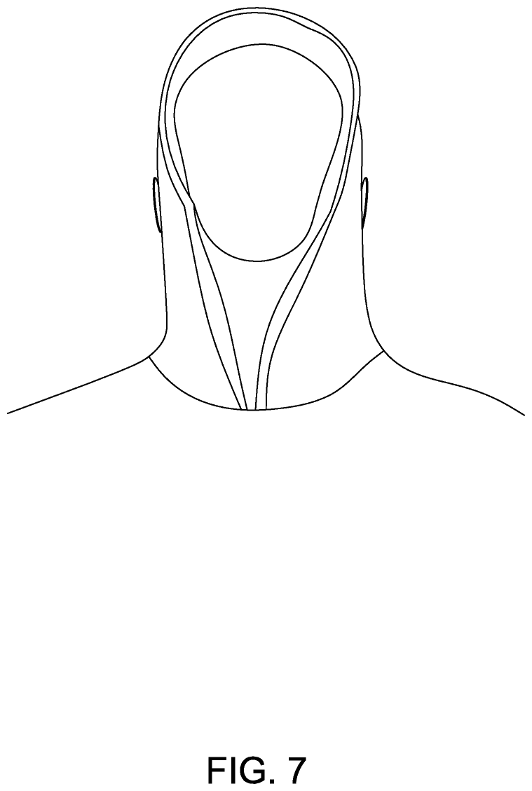

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope or the appended claims.

Referring to the drawings, a hoodie 10 is shown adapted to be worn on the upper torso, including traditional parts of a hoodie, long sleeves, and a body shirt having a fabric hand warmer pane! sewn to the front of the body shirt. The hoodie has attached to each side of the head of the hoodie, 10, at least one device, 20, which is used to attach the strings, 25, of a facemask, 30.

The device, 20, is attached with reinforcing stitched hem, Velcro, glue, adhesives, strings, or other means.

Accordingly, a provision for conveniently holding various objects is provided for a hoodie garment or other garments having a separate means to attach a facemask to the hoodie.

1. In combination with a hoodie or other similar garment having a button, hook or other means attached to the side of the hood portion of a hoodie wherein the button, hook or other attachments means is used to secure to the strings, straps, or other attachment means of a facemask.
